(19) United States
(12) Patent Application Publication
(10) Pub. No.: US 2026/0132264 A1
(43) Pub. Date: May 14, 2026

(54) BLOCK COPOLYMER, METHOD FOR PRODUCING A BLOCK COPOLYMER, MEMBRANE, USE OF A MEMBRANE, AND METHOD FOR PRODUCING A MEMBRANE

(71) Applicant: Forschungszentrum Jülich GmbH, Jülich (DE)

(72) Inventors: Sebastian AUFFARTH, Nürnberg (DE); Jochen KERRES, Bubenreuth (DE)

(21) Appl. No.: 19/118,111

(22) PCT Filed: Jun. 20, 2023
(86) PCT No.: PCT/EP2023/066682

§ 371 Date: Apr. 3, 2025

(30) Foreign Application Priority Data
Dec. 12, 2022 (DE) 102022132913.5

(51) Int. Cl. C08J 5/22; B01J 39/20; B01J 47/12; C08F 8/06; C08F 8/14; C08F 8/36; C08F 8/40

(52) U.S. Cl. CPC C08J 5/225; B01J 39/20; B01J 47/12; C08F 8/06; C08F 8/14; C08F 8/36; C08F 8/40; C08J 2353/02

(57) ABSTRACT

The present invention relates to a block copolymer comprising at least two different polymer blocks, wherein one polymer block consists at least predominantly of a first, ion-conducting polymer, wherein the ion-conducting polymer has ion-conducting functional groups, and one polymer block consists at least predominantly of a second, mechanically flexible polymer, wherein the mechanically flexible polymer has a lower glass transition temperature than the ion-conducting polymer, as well as a process for producing a block copolymer, a membrane and the use of a membrane.

The invention relates to a block copolymer with at least two different polymer blocks.

Furthermore, the invention relates to a method for producing such a block copolymer, as well as to a membrane and the use of a membrane. The invention also relates to a process for producing a membrane.

As part of the energy transition, alternative ways of generating and storing electricity are increasingly being developed. Fuel cells are an important part of this. These convert the chemical reaction energy of a supplied fuel and an oxidizing agent into electrical energy. In addition to hydrogen fuel cells, one group of fuel cells are the so-called direct alcohol fuel cells. Other relevant electrochemical processes include electrolysis processes or redox-flow batteries.

Membranes, especially ion exchange membranes, are used in such electrochemical processes. High demands are placed on such membranes. On the one hand, they must be sufficiently chemically stable against the media surrounding them in relation to their field of application. In addition, such membranes are often exposed to mechanical stresses. Electrochemical applications also require a certain degree of conductivity combined with a low degree of swelling, i.e. low volume expansion.

Due to their high ionic conductivity, special ion-conducting polymers, also known as ionomers, are used as the base material for the production of ion-conducting membranes. In addition to the properties described above, the highest possible conductivity in the desired temperature range of the respective application is desired. Other desired properties are ion-selective transport within such an ionomer membrane, as well as the separation of the various reaction chambers at the electrodes and the prevention of reactant transfer, i.e. the highest possible impermeability.

Proton exchange membranes made from Nafion are often used for low-temperature applications, i.e. for operating temperatures below 100° C. Nafion is a sulphonated tetrafluoroethylene polymer (PTFE). This is a sulfonated tetrafluoroethylene polymer (PTFE), which was developed by Dupont as a modification of Teflon. Specifically, it is an ionomer that is obtained by copolymerizing a non-polar monomer with a polar monomer. In order to reduce the diffusion of reactants to the cathode/anode side, relatively thick membranes (with a thickness >50 μm) or membranes with special reinforcing layers and additives, which are marketed under the name Nafion XL, for example, are usually used.

In principle, such polymers or membranes made of such polymers have proven their worth as long as water is present during operation. At operating temperatures above 100° C., sufficient hydration is no longer present, which is why sulfonated polymers generally have a significantly reduced conductivity for such applications, which prevents the materials from being used at such temperatures.

Phosphonated polymers and polymers doped with phosphoric acid exhibit sufficient conductivity in the corresponding application even at operating temperatures above 100° C. In some cases, there is the problem that such doped ion-conducting polymers, such as polybenzimidazole, lose phosphoric acid at temperatures below 140° C. or during frequent start-stop cycles, as a result of which the ionic conductivity decreases if no further doping takes place.

Polymers with ion-conducting groups often have a high glass transition temperature, which means that they are in a glassy state at typical application temperatures. Accordingly, the material has rather brittle properties, so that cracks can occur under certain stresses. For example, brittle cracks can form in membranes made of certain polymers, e.g. phosphonated terphenyl-based polymers, after the evaporation of water.

The object of the present invention is therefore to provide a polymer which is characterized by a favorable property profile and avoids the aforementioned disadvantages. Furthermore, a process for the production of such a polymer is to be created.

This problem is solved by a block copolymer having at least two different polymer blocks, one polymer block consisting at least predominantly of a first, ion-conducting polymer, the ion-conducting polymer having ion-conducting functional groups, and one polymer block consisting at least predominantly of a second, mechanically flexible polymer, the mechanically flexible polymer having a lower glass transition temperature than the ion-conducting polymer.

The invention is based on the idea of combining an ion-conducting polymer and another polymer in a block copolymer. While the ion-conducting polymer has rather brittle material properties, the other, mechanically flexible polymer has a higher ductility, in particular due to the lower glass transition temperature, so that mechanical loads are absorbed by this polymer block. A further advantage of such a block copolymer is that, unlike an ion-conducting homopolymer, no stabilization with a polymer blend, for example with polybenzimidazole (PBI), is required so that no ion-conducting groups are lost through ionic cross-linking. As a result, the polymer block made of one ion-conducting polymer enables unproblematic ion conductivity, whereas the other polymer block made of a second, mechanically flexible polymer ensures favorable mechanical properties. At the same time, the length of the individual polymer blocks can be adjusted practically at will, so that the resulting block copolymer can be adjusted very precisely in terms of its properties. The two polymer blocks are preferably covalently linked to each other

The block copolymer can be a diblock copolymer. This means that each polymer chain has a section/block with the ion-conducting polymer and a section/block with the mechanically flexible polymer. In other words, the individual polymer chains have the structure A-B. It is also possible that the block copolymer is a triblock copolymer. This means that the polymer chains have a block on one polymer, then a block of the other polymer and another block of the one polymer. The one polymer and the other polymer can be either the mechanically flexible polymer or the ion-conducting polymer. In other words, such a triblock copolymer has the structure A-B-A or B-A-B. It is also possible that the three polymer blocks of such a triblock copolymer are designed differently. Such a block copolymer can also have or consist of three different polymer blocks. In simplified terms, the structure A-B-C can be formed. Alternatively, the block copolymer can also be a quad-block copolymer, in which the polymer chains alternately form a block on the mechanically flexible polymer, from the ion-conducting polymer, again from the mechanically flexible polymer and again from the ion-conducting polymer, in other words with an A-B-A-B structure. Two, three or four different polymer blocks are also possible in a quad-block copolymer. The polymer chains can also have more than four blocks. In general, one can then speak of multiblock copolymers. It has been found that triblock copolymers and quadblock copolymers or multiblock copolymers can have more favorable properties, in particular more favorable mechanical properties or lower swelling, compared to diblock copolymers due to the increased number of transitions between the different polymer blocks.

Preferably, the mechanically flexible polymer has a higher ductility than the ion-conducting polymer. The ductility is a measure of the deformability, in particular the elongation at break. In other words, the mechanically flexible polymer can be deformed more before it breaks than the ion-conducting polymer. In particular, this applies to temperatures below 120° C., preferably below 100° C., particularly preferably at room temperature. This ensures that a certain deformability is present, which allows a membrane consisting of the block copolymer to be installed without the risk of it becoming brittle. Especially at higher temperatures above 100° C. and in the absence of humidification, mechanical flexibility can be ensured by the block made of the mechanically flexible polymer.

A polymer block can consist predominantly or essentially of a polymer if the proportion of the respective mechanically flexible or ion-conducting polymer is at least 50%, in particular at least 80%, preferably at least 90%, more preferably at least 95%, 98% or 99%. The polymer blocks can also consist entirely of the respective mechanically flexible or ion-conducting polymer.

The problem underlying the invention is further solved by a process for producing such a block copolymer, which comprises the following steps:
provision of a first starting monomer;
provision of a second output monomer;
polymerization of the starting monomers, so that a block copolymer with at least two different polymer blocks is formed, wherein one polymer block consists at least essentially of a first (ion-conducting) polymer and wherein one polymer block consists at least essentially of a second, mechanically flexible polymer;
functionalizing the first polymer so that it has an ion-conducting functional group.

According to the invention, it is thus intended to produce a block copolymer by polymerizing two starting monomers. Subsequently, functionalization can take place so that the first polymer is provided with ion-conducting functional groups.

The invention further includes a process for producing a block copolymer comprising the following steps:
provision of a first starting monomer;
functionalization of the starting monomer so that it has an ion-conducting functional group;
provision of a second output monomer;
polymerization of the starting monomers to form a block copolymer comprising at least two different polymer blocks, wherein one polymer block consists at least essentially of a first, ion-conducting polymer, wherein the ion-conducting polymer comprises an ion-conducting functional group, and wherein one polymer block consists at least essentially of a second, mechanically flexible polymer.

This process is based on the idea of functionalizing the starting monomer, i.e. providing it with corresponding functional groups that are ion-conductive after polymerization.

According to a preferred embodiment of the block copolymer according to the invention, the glass transition temperature of the mechanically flexible polymer is less than 80° C., in particular less than 60° C. Such a relatively low glass transition temperature is particularly suitable if the block copolymer is operated in connection with a low-temperature fuel cell/electrolyzers, in particular in the absence of humidification and/or in particular below 100° C., preferably below 60° C. This is the case, for example, with direct alcohol fuel cells.

The glass transition temperature of the mechanically flexible polymer can be less than 200° C. Such a glass transition temperature means that the mechanically flexible polymer is mechanically flexible, i.e. not brittle, even at temperatures below 200° C. and is therefore suitable for use in high-temperature hydrogen fuel cells.

The glass transition temperature refers to a temperature at which the property profile of the corresponding polymer changes. Above the glass transition temperature, such a polymer is generally described as mechanically flexible, so that it can be easily formed and the occurrence of brittle cracks can generally be avoided. Below the glass transition temperature, which is also referred to as TG, the property profile changes. The polymer becomes hard and solid and loses ductility, which can lead to brittle cracks. The glass transition temperature can be measured using various methods. Dynamic mechanical analysis (DMA) registers a strong change in the modulus of elasticity or shear modulus. Another method for determining the glass transition temperature is dynamic differential scanning calorimetry (DSC), for example in accordance with DIN EN ISO 11357-2:2020-08. Here, the measurement is carried out by determining the heat capacity as a function of temperature. Other measurement options are electrical relaxation spectroscopy or dilatometry.

Preferably, the mechanically flexible polymer, which forms a polymer block, has a high hydrolysis resistance or is hydrolysis-resistant. In other words, it has a high chemical stability against water. Preferably, it is stable even at extreme, i.e. very acidic or very basic pH values of up to pH 0 or 14. It is also preferably resistant to alcohols, in particular methanol and isopropanol. The mechanically flexible polymer can also be apolar or non-polar. In a further embodiment, it may contain no degradable and hydrolyzable functional groups.

Preferably, the mechanically flexible polymer is not an acrylate polymer. This embodiment is based on the consideration that acrylate polymers, i.e. polymers of acrylate or comprising acrylate, have proven to be insufficiently stable or resistant to hydrolysis.

In a preferred embodiment, the mechanically flexible polymer does not contain any hydrolysable groups. This means that such a mechanically flexible polymer has a high resistance to hydrolysis. Hydrolysis is a chemical reaction in which the bond of a molecule is broken by water. This is associated with far-reaching changes in the properties of the molecule/polymer.

In a specific embodiment, the mechanically flexible polymer can be a vinyl-based polymer, in particular polybutadiene, polyisoprene, polypropylene, polyvinylidene fluoride or polyvinyl fluoride, or a substituted styrolized polymer, in particular poly-4-n-octylstyrene.

Possible repeating units or starting monomers that can form the mechanically flexible polymer are shown in the figure below. “n” represents an unbranched or branched alkyl chain, X a functional group that can be used for subsequent functionalization or crosslinking.

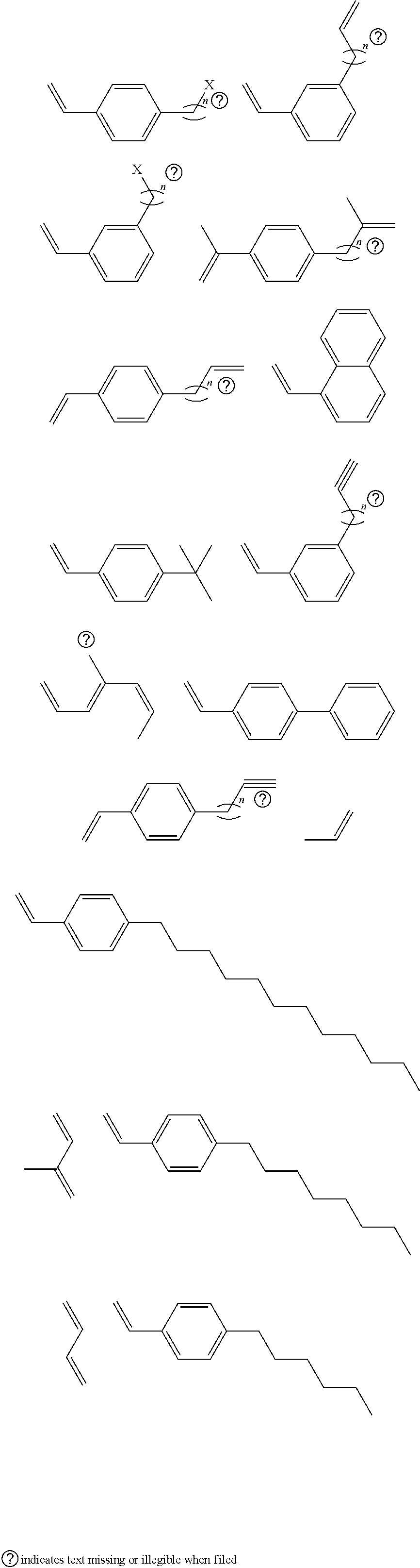

Possible (starting) monomers that contain functional, ion-conducting groups or can be converted into repeating units of an ion-conducting polymer by corresponding reactions after polymerization are shown in the following figure.

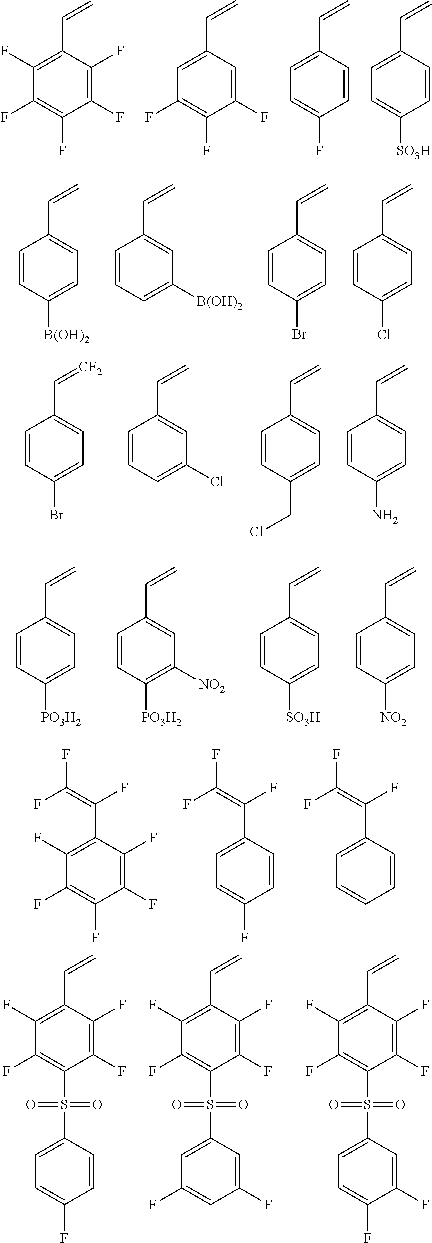

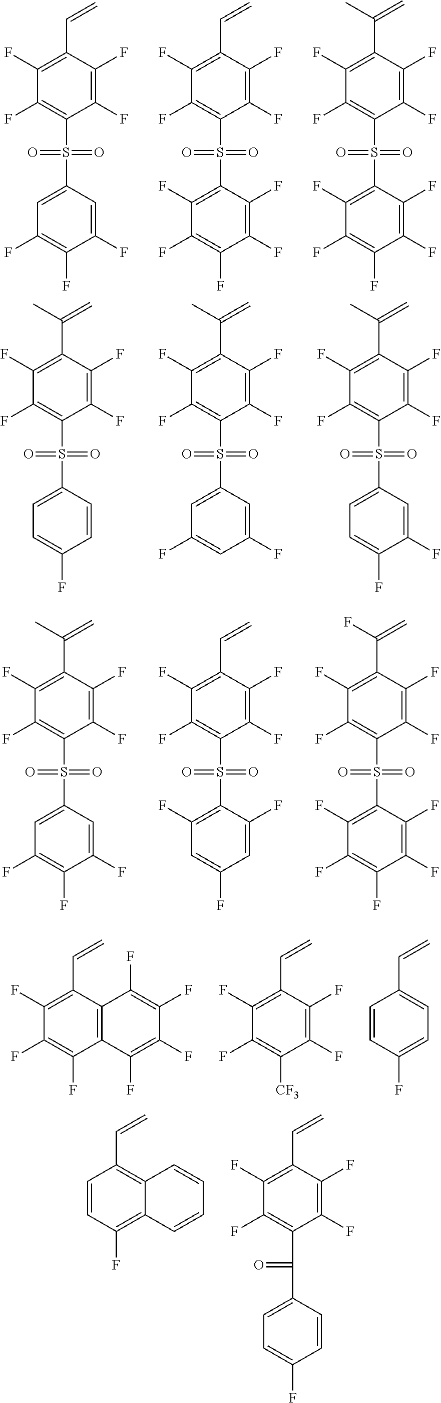

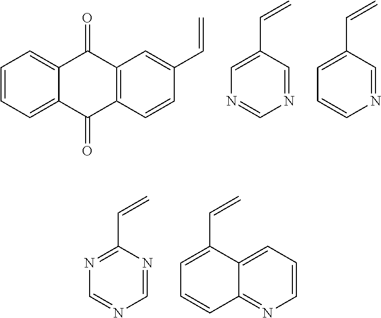

According to a preferred embodiment of the invention, the ion-conducting polymer may contain or consist of polyfluorostyrenes, in particular polypentafluorostyrene and/or analogs thereof. Analogs are defined as polyfluorostyrenes in which at least one fluorinated site is present on the aromatic compound.

In a further embodiment, a fluorinated site, or a fluorine atom, on the aromatic compound can be replaced by substitution with an ion-conducting functional group. This may preferably be a nucleophilic substitution. The ion-conducting functional group may be a sulfonic acid and/or a phosphonic acid group and/or a precursor thereof. A precursor may be, for example, a sulfochloride group (—SO₂Cl) or a superacidic sulfonimide group (SO₂NHSO₂CF₃).

Examples of polystyrenes that have at least one fluorinated site on the aromatic compound per repeating unit are shown in the figure below.

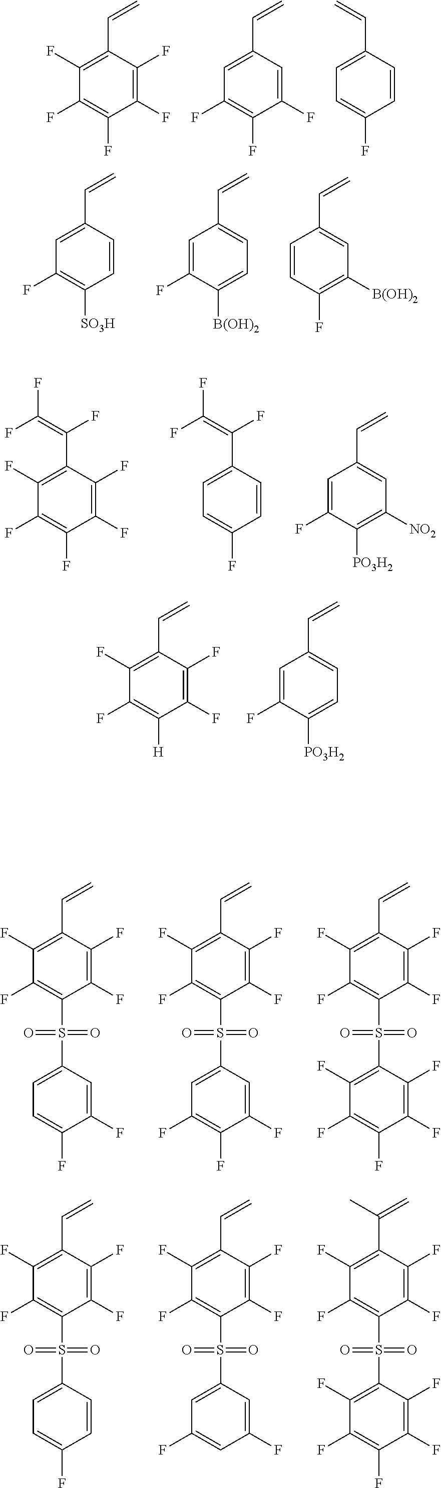

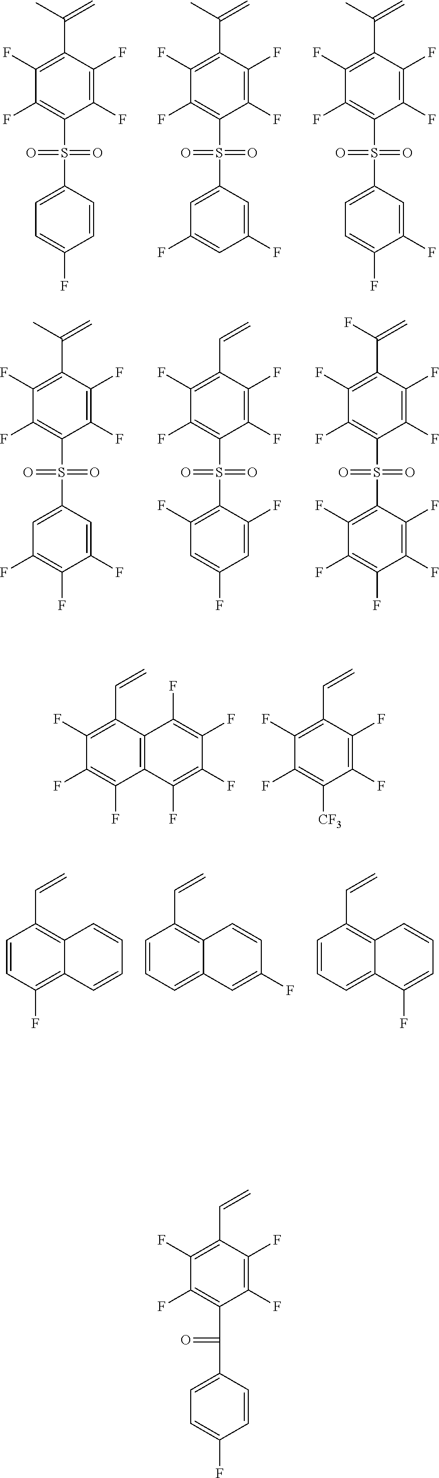

The ion-conducting functional groups of the ion-conducting polymer may comprise acidic functional groups, wherein the acidic functional groups include in particular sulfonic acid, sulfinic acid, phosphonic acid or sulfonimide or non-ionic forms thereof. The ion-conducting functional groups of the ion-conducting polymer may also comprise basic functional groups, wherein the basic functional groups comprise in particular primary, secondary or tertiary amines, imidazoles, pyrazoles, benzimidazoles, pyridines, or quaternary functional groups, in particular ammonium and/or imidazolium and/or pyrazolium and/or pyridinium groups or cations, in particular tetraalkylphosphonium and/or tetraarylphosphonium and/or metallocene-based anion conductors.

It is possible that different functional groups are provided on the ion-conducting polymer or that the ion-conducting polymer contains different functional ion-conducting groups. For example, the ion-conducting polymer can contain both acidic functional groups and basic functional groups.

The block of ion-conducting polymer may have an ion-conducting functional group in each repeating unit or may have an ion-conducting functional group in only some of the repeating units.

In a further embodiment, the block copolymer according to the invention may comprise at least two microphases, wherein one microphase consists at least predominantly of the ion-conducting polymer and another microphase consists at least predominantly of the mechanically flexible polymer. In other words, such a co-polymer can thus have microphase-separating properties, i.e. two different microphases are formed, one microphase being dominated by the ion-conducting polymer and the other microphase being dominated by the mechanically flexible polymer. The microphases can also consist entirely of the mechanically flexible polymer or of the ion-conducting polymer.

In a further embodiment, the microphase of the ion-conducting polymer can be formed continuously. This means that the microphase made of the ion-conducting polymer extends continuously through the entire block copolymer, so that a conductive connection exists between two outer surfaces in a membrane made of such a block copolymer. In other words, the microphase of the mechanically flexible polymer is then embedded in such a continuous microphase. For example, corresponding inclusions can be distributed in the block copolymer.

Specifically, the microphase of the ion-conducting polymer can have a volume fraction of at least 35% or at least 50%, in particular at least 60%, preferably at least 70%. In such a case, it can be achieved that a continuous microphase is formed from the ion-conducting polymer. This results in continuous conductivity.

The microphase of the ion-conducting polymer and/or the microphase of the mechanically flexible polymer can be designed in such a way that the distance between two opposing interfaces to another microphase is less than 200 nm, in particular less than 150 nm, preferably less than 100 nm, more preferably less than 75 nm, less than 50 nm, less than 35 nm, less than 25 nm or less than 20 nm. In such a case, the two phases are in the nanometer range, which is why they are also referred to as nanophases. In other words, the block copolymer in this case forms a nanostructure, for example a bi-continuous nanostructure, wherein the individual regions, when viewed in a cross-sectional view, preferably have extensions in a direction of less than 200 nm, in particular of less than 150 nm, preferably of less than 100 nm, more preferably of less than 75 nm, less than 50 nm, less than 35 nm, less than 25 nm or less than 20 nm. Preferably, the distance between two opposing interfaces to another microphase is at least 1 nm, in particular at least 2 nm, preferably at least 3 nm, more preferably 4 nm or 5 nm. Such a nanophase structure can be detected, for example, by High-Angle Annular Dark-Field imaging (HAADF)-Scanning Transmission Electron Microscopy (STEM).

If the block copolymer is a triblock copolymer or a quadblock copolymer or generally speaking—a multiblock copolymer, the more frequent transitions between the individual polymer blocks and thus between the different microphases or nanophases compared to a diblock copolymer lead to a more intensive merging of the phases into one another, resulting in particularly favorable mechanical properties and/or low swelling of a membrane produced or consisting of the block copolymer.

Preferably, the block copolymer does not have any lamellar structures. Instead, the microphases or nanophases can have a gyroidal structure. This simultaneously results in isotropic material properties, so that direction-independent ion transport or direction-independent conductivity can be achieved.

The ratio of the number of repeating units of the block of the ion-conducting polymer to the number of repeating units of the block of the mechanically flexible polymer can be at least 10:90, in particular at least 25:75, preferably at least 50:50, and/or at most 90:10, in particular at most 75:25. In other words, it is possible to adjust the length ratios in the block copolymer depending on the respective requirements. If higher demands are placed on the mechanical flexibility of the block copolymer or a membrane made from it, the length of the block made from the mechanically flexible polymer can be increased and the length of the block made from the ion-conducting polymer can be reduced in proportion. If, on the other hand, the conductivity is to be as high as possible and the mechanical properties are required to be rather low, the length of the block made of the ion-conducting polymer can be increased and the length of the block made of the mechanically flexible polymer can be reduced in relation to this. If two different microphases are formed, the volume ratio of the two microphases to each other changes accordingly.

In a further embodiment, polymer blocks made of the ion-conducting polymer and/or polymer blocks made of the mechanically flexible polymer can be covalently and/or ionically cross-linked with each other or with each other. Such ionic or covalent cross-linking can significantly reduce the diffusion of the fuel and the oxidation product to the cathode side. Sometimes even all diffusion can be prevented. In addition, higher power densities can sometimes be achieved in this way.

The ion-conducting polymer may contain or be coupled to partially or perfluoroaromatic compounds. Accordingly, the blocks of the ion-conducting polymer can be covalently crosslinked with one another via their partially or perfluoroaromatic compounds.

These embodiments are based on the idea of creating an additional covalent cross-linking by means of a nucleophilic substitution reaction on the backbone using a difunctional cross-linking agent. Such additional covalent crosslinking requires the presence of partially or perfluoroaromatic compounds on which individual fluorine atoms can be nucleophilically substituted by a corresponding functional group. It has been shown that membranes consisting of such covalently cross-linked block copolymers are chemically significantly more stable, especially towards secondary alcohols and towards compounds containing at least one secondary alcohol group. Furthermore, the resistance to secondary alcohols and the reaction products in the fuel cell reaction, in particular ketones and water, has also been shown to be significantly higher than that of Nafion.

The partially or perfluoroaromatic compound can be contained in the main or side chain of the respective polymer. Examples of partially or perfluoroaromatic assemblies of ionomers/polymers that are suitable for covalent crosslinking are shown in the figures below. Even if the figure refers to polymer main chains and side chains, the corresponding structures apply equally to both polymer blocks.

Assemblies in the polymer main chain:

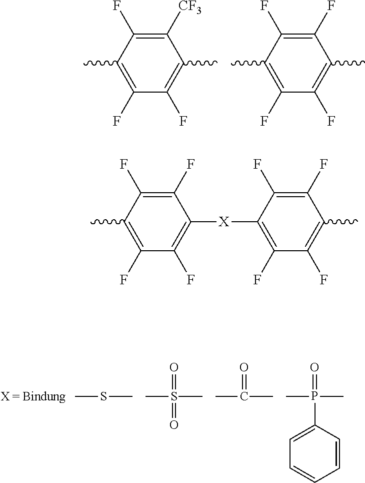

Assemblies in the polymer side chain:

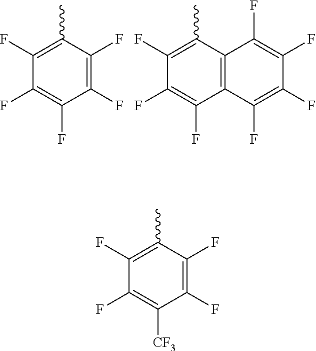

Specifically, the partially or perfluoroaromatic compound may contain a partially or perfluorinated phenyl moiety or a partially fluorinated or perfluorinated biphenyl moiety.

The covalent crosslinking can have the structure S-R-S, wherein each sulphur atom substitutes a fluorine atom of a partially or perfluoroaromatic compound. R can stand for a linear or branched saturated or unsaturated carbon chain, in particular in the form (CH₂)ₓ with x=2 to 20, or for a heteroaromatic chain, in particular poly- or oligoethylene glycol, or for any aromatic compound, in particular 1,4-dimercaptobenzene, biphenyl-4,4′-dithiol or toluene-3,4-dithiol. In other words, the covalent crosslink can be produced by a dithiol, so that at both ends of the covalent crosslink a sulphur atom takes the place of a fluorine atom of a partially or perfluoroaromatic compound. In principle, crosslinkers with more than two thiol groups are also conceivable for crosslinking, for example trimethylolpropane tris(3-mercaptopropionate).

The ion-conducting polymer can contain both acidic and basic functional groups, with ionic cross-links being formed between the acidic and basic functional groups. Alternatively, the block copolymer according to the invention can also be mixed with another basic polymer such as polybenzimidazole to form an acid-base blend. The acid-base blend thus obtained contains opposing functional groups which can be ionically crosslinked with each other. Such a possible cross-linking is shown in detail in the figure below.

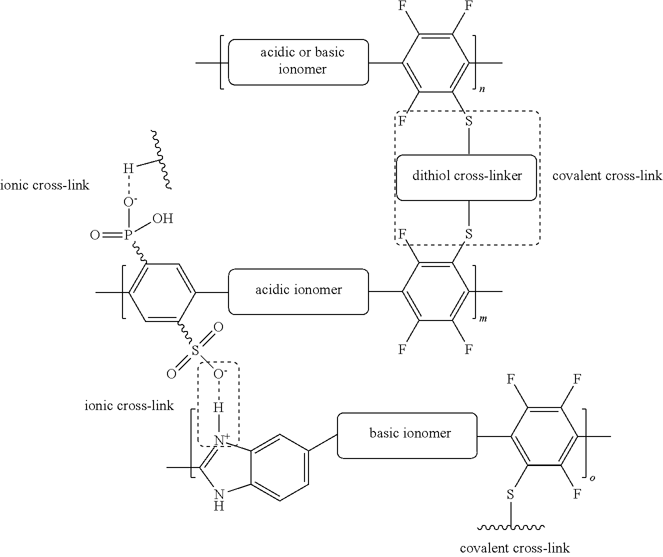

Covalent cross-linking of the polymer block from the second, mechanically flexible polymer is also possible. For example, the unsaturated double bonds in polyisoprene, polybutadiene can be vulcanized or a double bond within an aliphatic side chain can be used. In addition to the mechanically flexible behavior, additional elastomeric, reversible properties can be achieved through cross-linking. This explicitly ensures that the block copolymer and the materials consisting of this block copolymer return to their original shape after mechanical stress. Any known process can be used for cross-linking, such as vulcanization. Possible examples of covalent cross-linking of the mechanically flexible polymer are shown in the figure below.

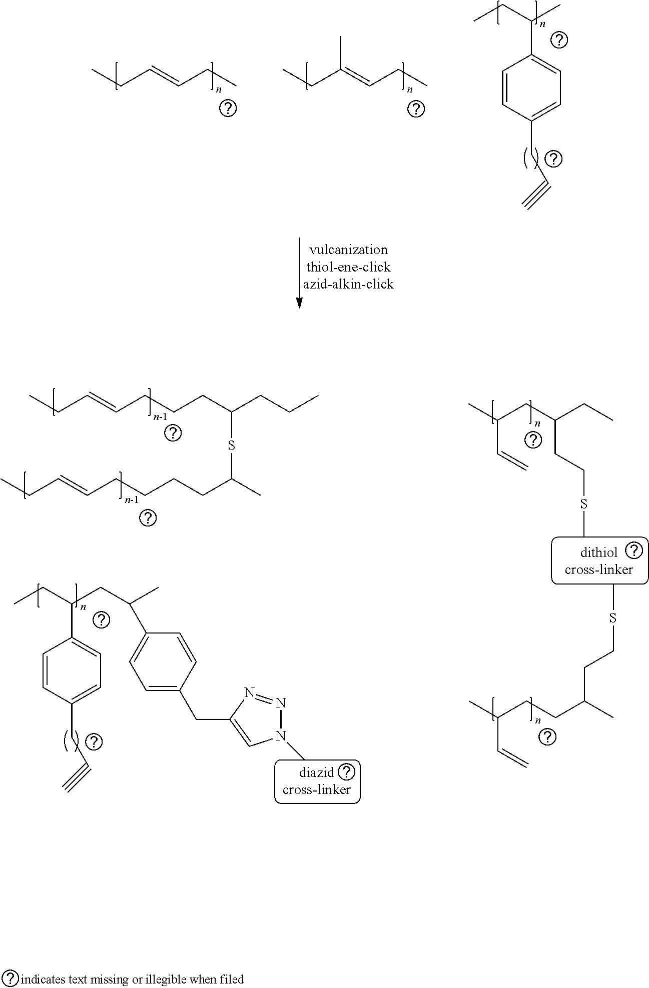

The process according to the invention may be characterized in that cationic or anionic polymer initiators are used for polymerization, and/or in that the polymerization comprises atom transfer radical polymerization (ATRP), nitroxide mediation and/or reversible addition fragmentation change-transfer polymerization (RAFT).

In a further embodiment, the polymer blocks made of the ion-conducting polymer can be covalently and/or ionically cross-linked with each other or among each other. Furthermore, the polymer blocks made of the mechanically flexible polymer can be covalently and/or ionically cross-linked with each other or with each other. Such cross-linking can further optimize the properties of the block copolymer.

Preferably, two separate microphases are formed during polymerization, one microphase consisting at least predominantly of the ion-conducting polymer and another microphase consisting at least predominantly of the mechanically flexible polymer.

In a further embodiment of the method according to the invention, a further functional modification, in particular of the microphase of the mechanically flexible polymer, can be carried out. In particular, as part of the further functional modification, further functional groups, in particular further ion-conducting functional groups, can be introduced into the mechanically flexible polymer. This can result in a further ion-conducting microphase. Specifically, functional groups that are formed during polymerization, in particular double bonds in side chains of a polyisoprene/polybutadiene block by 1,2 addition, or by using corresponding apolar monomers, which in particular comprise or consist of halides or unsaturated groups, can be introduced. These can be further functionalized.

The properties can be further optimized by creating a further microphase from a second ion-conducting polymer, which has its own conduction mechanism. In other words, a combination material can be produced which has special microphases for the transport of protons/cations in humidified and dry conditions. For example, humidified conditions exist at temperatures below 100° C. at ambient pressure, whereas dry conditions have temperatures above 100° C. at ambient pressure.

Examples of further functional modifications are shown in the figure below.

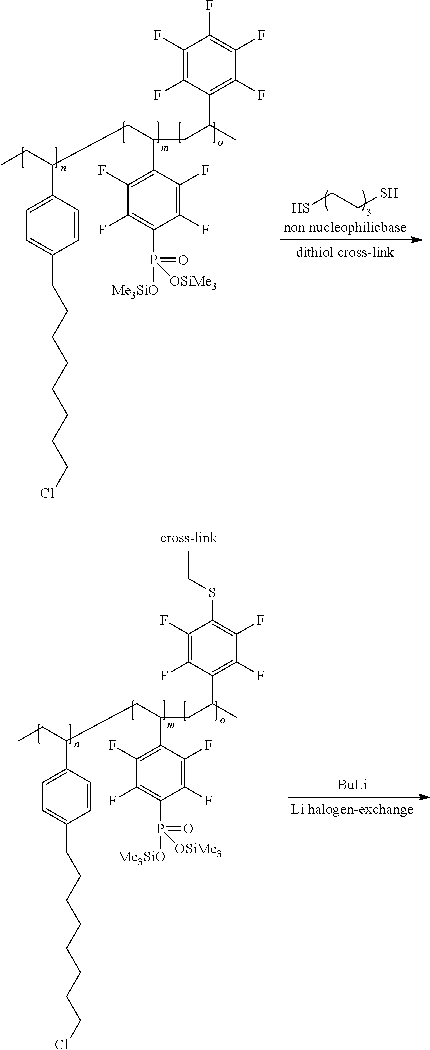

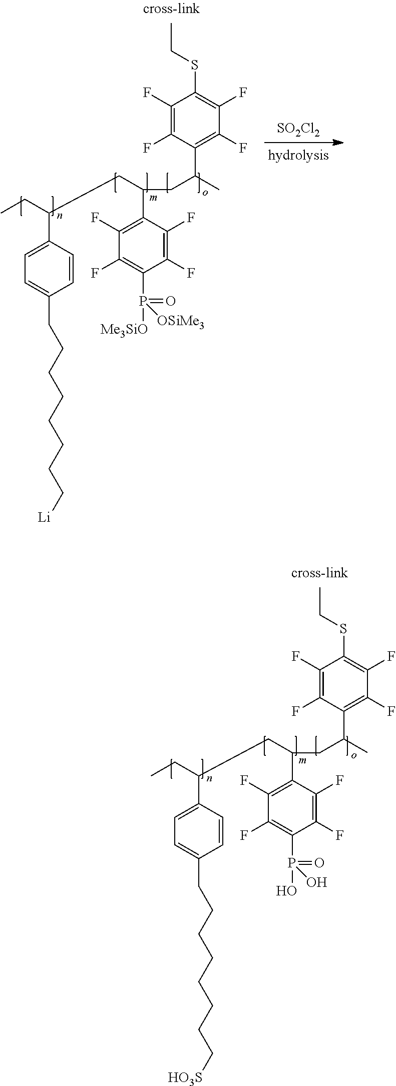

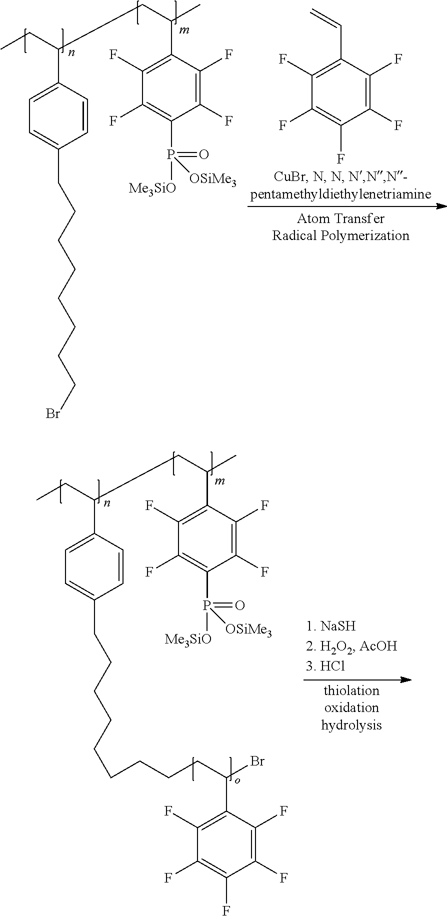

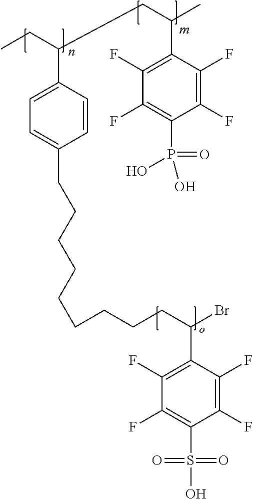

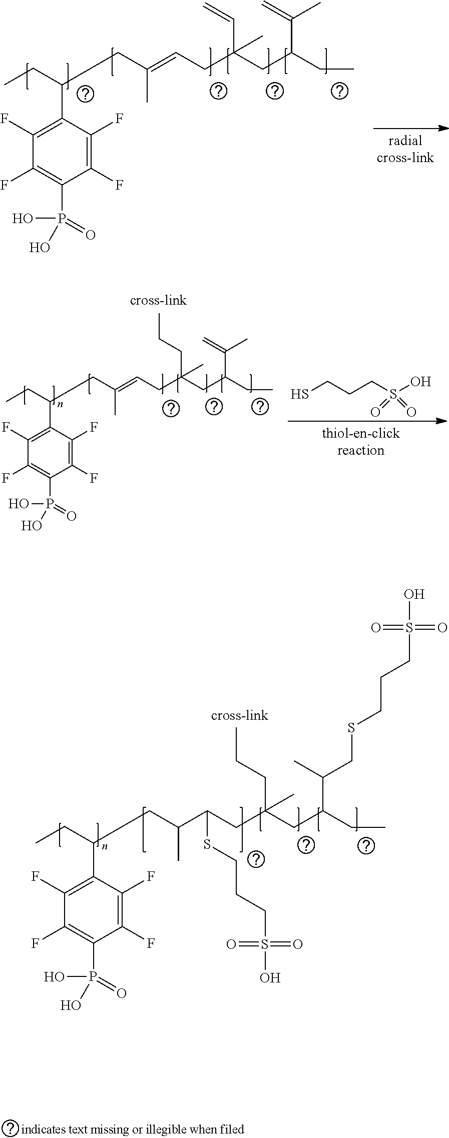

The further functional modification may comprise partial or complete thiolation, in particular in an electrolyte solution and/or in a salt solution. Furthermore, the further functional modification may comprise an oxidation of the thiol group to a sulfonic acid group.

The problem underlying the invention is further solved by a membrane comprising or consisting of a block copolymer as described above. Preferably, the thickness of the membrane is less than 100 μm, in particular less than 75 μm, preferably less than 50 μm. This embodiment is based on the consideration that membranes made of such a block copolymer have favorable properties, so that they can be designed to be significantly thinner than, for example, a membrane made of Nafion or Nafion XL.

Preferably, the membrane has a conductivity of at least 22 mS/cm, in particular of at least 25 mS/cm, preferably of at least 30 mS/cm, particularly preferably of at least 32 mS/cm.

The invention also relates to the use of such a membrane as a proton exchange membrane in a direct alcohol fuel cell, in particular in a direct methanol fuel cell or in a direct isopropanol fuel cell, or in a hydrogen fuel cell or in a hydrogen electrolyzer, for reducing fuel and oxidation product diffusion across the membrane and with increased resistance to solvents. Application in redox flow batteries is also conceivable.

Furthermore, the invention provides a method of manufacturing a membrane comprising the following steps:
providing a block copolymer, in particular as described above and/or produced by a process as described above;
partial or complete thiolation of the polymer, in particular by nucleophilic substitution of a fluorine atom, preferably a polyfluorostyrene, particularly preferably a perfluorophenyl unit or a perfluorobiphenyl unit or a perfluoroterphenyl unit, which is arranged in particular in a side chain of the polymer;
forming a membrane from the thiolated polymer, whereby cross-linking is formed in particular;
conversion of the thiol groups into ion-conducting sulfonic acid groups.

Such a process is based on the consideration that partial or complete thiolation of a block copolymer, particularly on a perfluoroaromatic compound, leads to a tendency for such polymers to crosslink. Such thiolated polymers are then no longer soluble in various solvents. The cross-linking that takes place when a membrane is molded, for example by casting or doctoring, can be used to produce solvent-resistant membranes. An alcohol solution, in particular an ethanol solution, can be used as an auxiliary material to form the membrane. On the formed membrane, the thiol groups formed during thiolation can then be converted into ion-conducting sulfonic acid groups by appropriate oxidative conditions. This results in increased solvent resistance and, at the same time, favorable ion-conducting properties. Partial phosphonation can take place before thiolation of the polymer. In this case, first partial phosphonation and then thiolation take place sequentially. Preferably, at least 30%, in particular at least 40%, preferably at least 50%, and/or at most 80%, in particular at most 70%, preferably at most 65% of the repeating units of the ion-conducting polymer are phosphonized. In particular, the repeating units of the mechanically flexible polymer are sulphonated.

It is also possible that only some of the repeating units of the ion-conducting polymer are sulphonated.

Preferably, the thiolation of the polymer takes place in an electrolyte solution and/or in a salt solution.

For further embodiments of the invention, reference is made to the subclaims and to the description of the embodiments with reference to the drawing. The embodiments described with reference to the figures represent preferred block copolymers according to the present invention. The reaction schemes show preferred embodiments of the processes according to the invention, with the parameters mentioned (auxiliaries, temperature or the like) showing optional embodiments of the respective processes. The drawing shows:

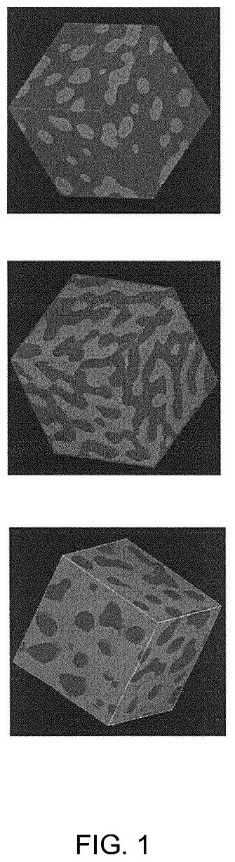

FIG. 1 the mesostructure of a POS-b-sPPFS block copolymer according to the invention;

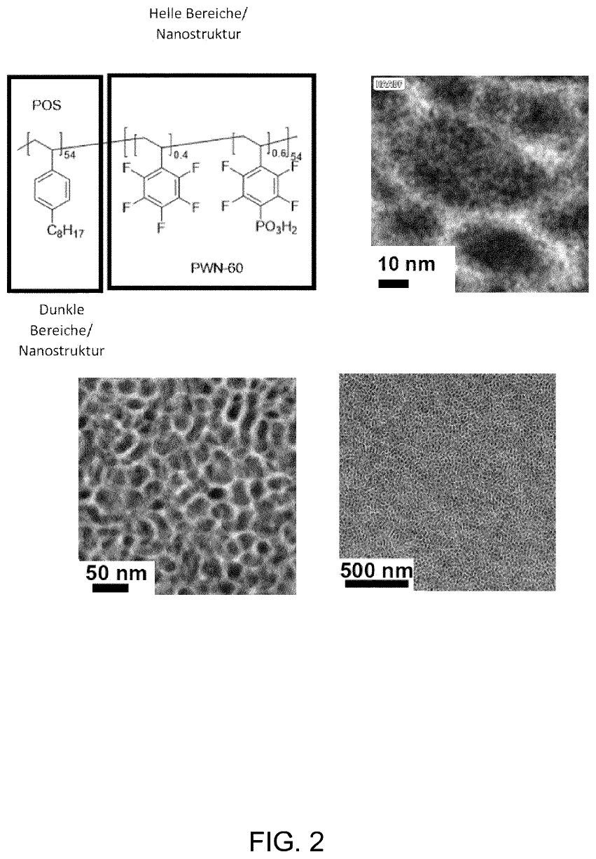

FIG. 2 structure of the block copolymer from FIG. 1 in HAADF-STEM images;

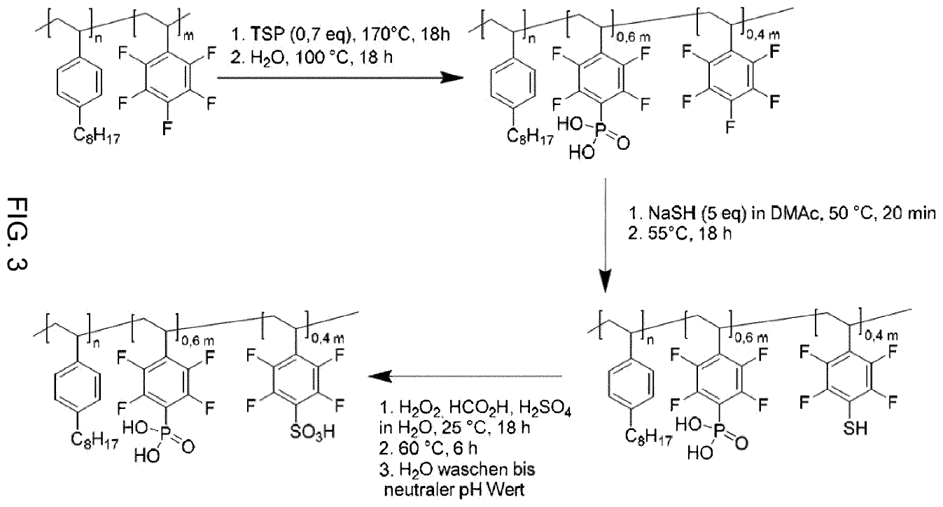

FIG. 3 a reaction scheme for sequential partial phosphonation and complete thiolation with subsequent oxidation and protonation;

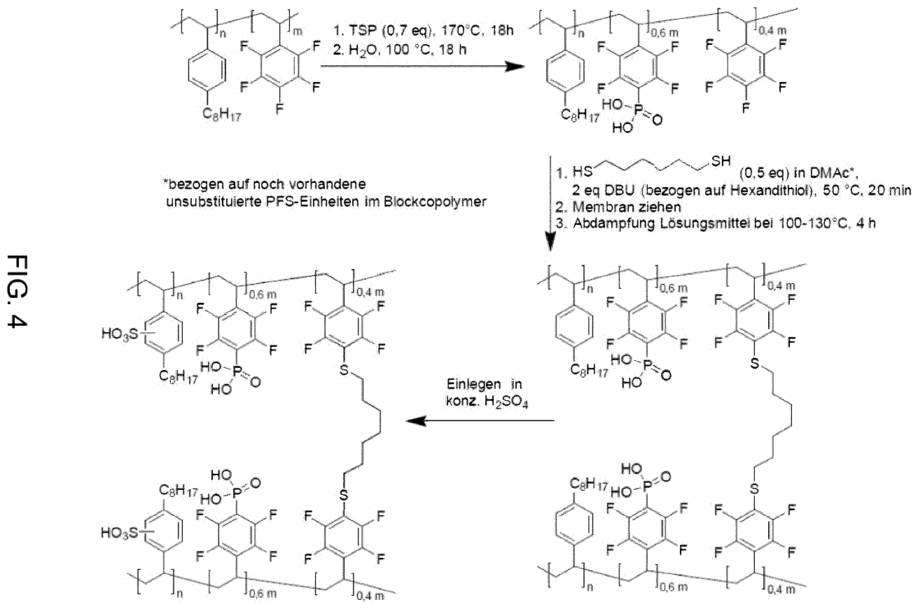

FIG. 4 a reaction scheme for the production of POS-PPFS block copolymers, which are phosphonated and crosslinked in the PPFS nanophase and sulfonated in the POS phase;

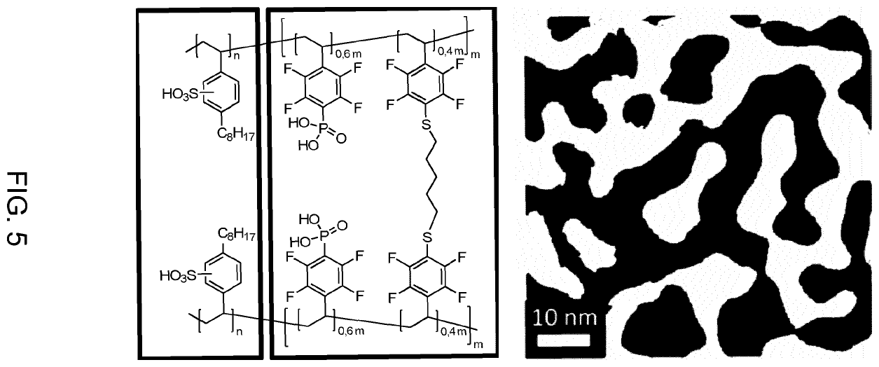

FIG. 5 the mesostructure of the polymer from FIG. 4;

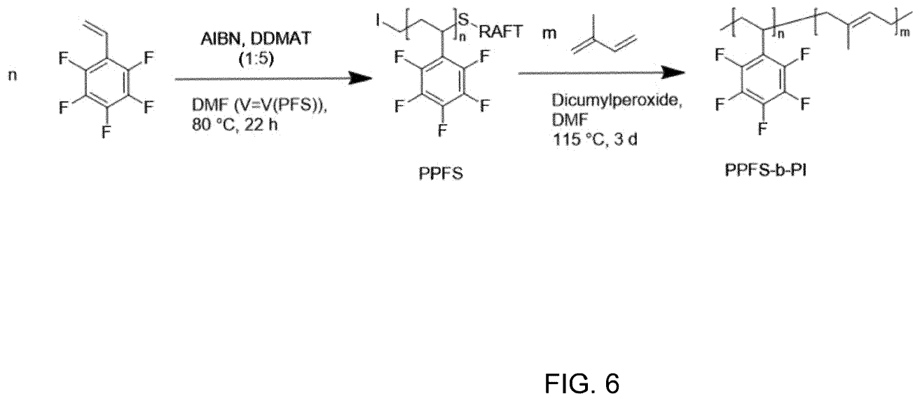

FIG. 6 the synthesis of polypentafluorostyrene block polyisoprene PPFS-b-PI;

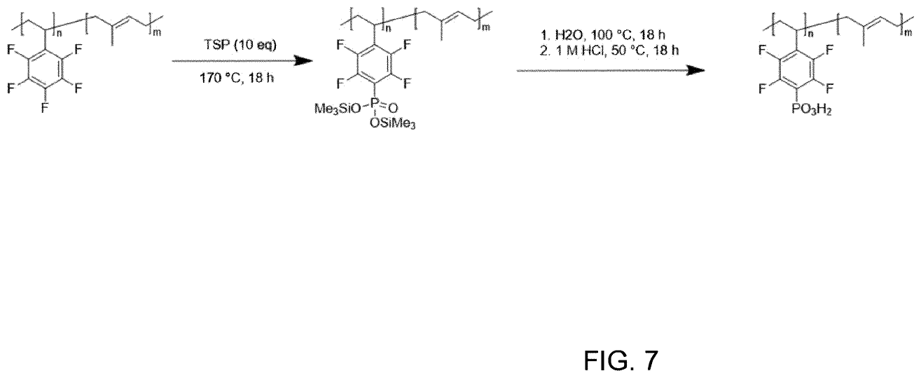

FIG. 7 the reaction scheme of the functionalization of PPFS-b-PI by means of complete phosphonation and partial thiolation;

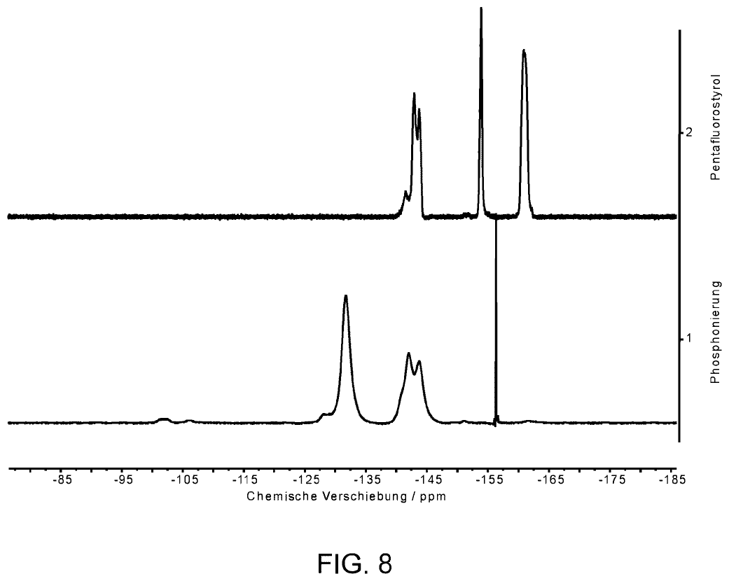

FIG. 8 a ¹⁹F-NMR spectrum of PPFS-b-PI and the crude product after a Michaelis-Arbuzow reaction;

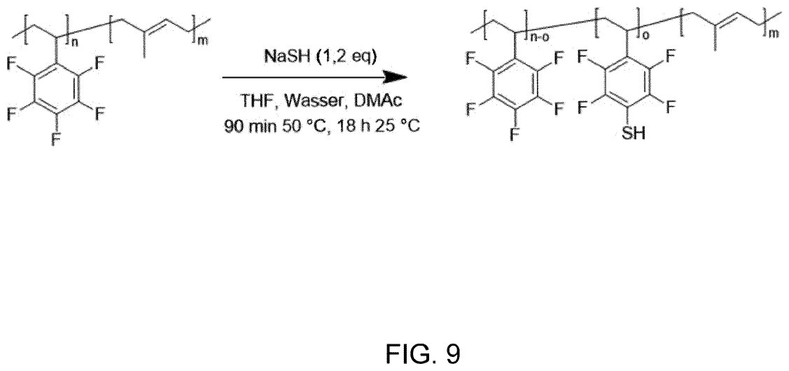

FIG. 9 a reaction scheme of a functionalization of PPFS-b-PI by means of partial thiolation;

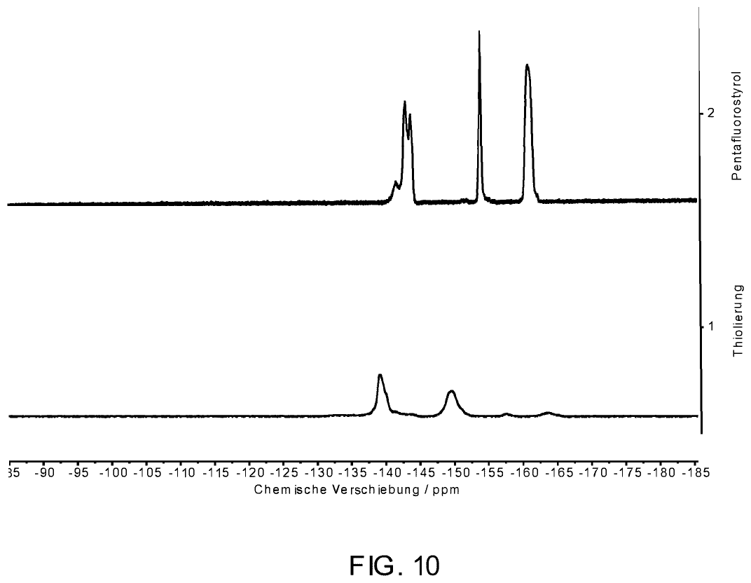

FIG. 10 a ¹⁹F-NMR spectrum of PPFS-b-PI and the crude product after thiolation with sodium hydrogen sulfide;

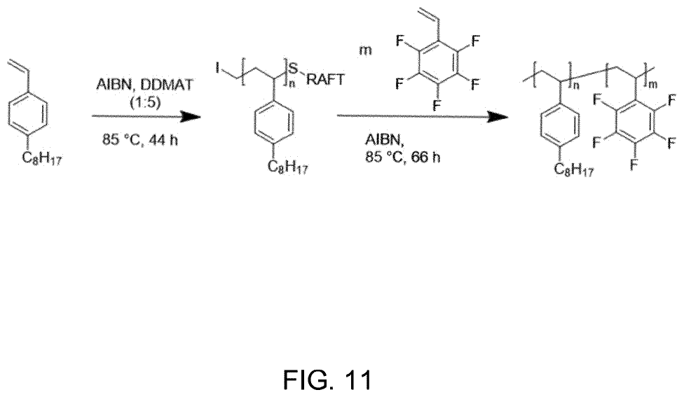

FIG. 11 the reaction scheme of a synthesis of polyoctystyrene block polypentaflurstyrene POS-b-PPFS;

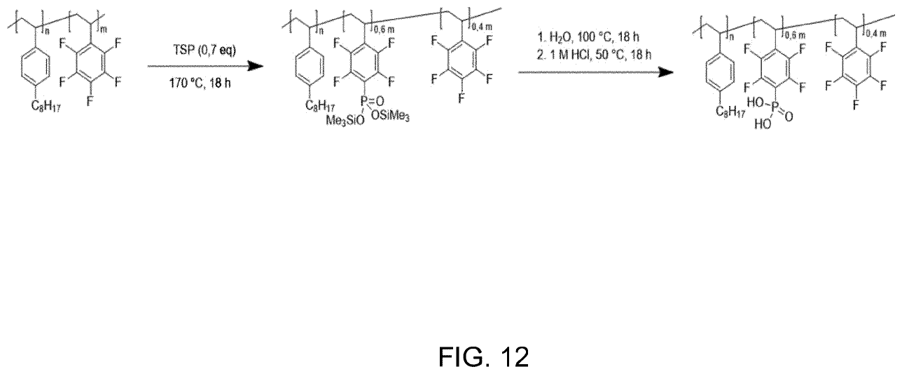

FIG. 12 a reaction scheme of a functionalization of POS-b-PPFS by means of partial phosphonation;

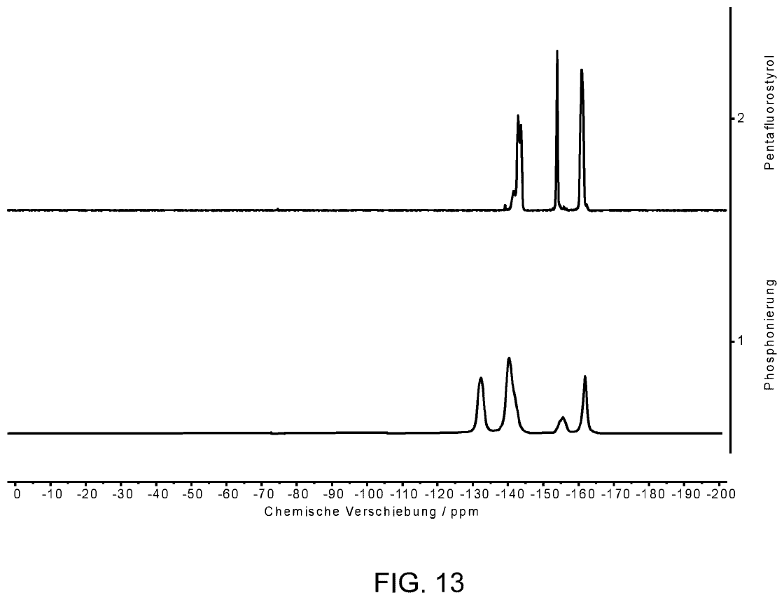

FIG. 13 a ¹⁹F-NMR spectrum of POS-b-PPFS and the crude product after Michaelis-Arbuzow reaction;

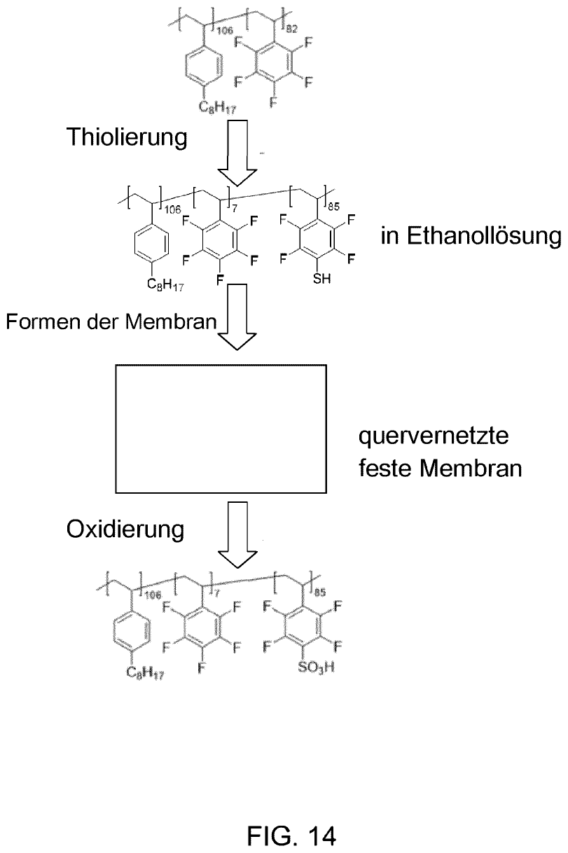

FIG. 14 a scheme for the production of a membrane from a block copolymer with crosslinking and ion-conducting sulfonic acid groups.

FIG. 1 first shows a simulation of the microphase of a block copolymer according to the invention, specifically polyoctylstyrene block sulfonated polypentafluorostyrene (POS-b-sPPFS), depending on the respective block lengths used, i.e. the number of respective repeating units in the two blocks. Polyoctylstyrene forms a mechanically flexible polymer, whereas sulfonated polypentafluorostyrene forms an ion-conducting polymer.

To synthesize the block copolymers, the various blocks were produced using RAFT polymerization. The polymer block made of polypentaflurstyrene was subsequently modified with an acidic functional group as an example.

Using the Biovia Materials Studios software from Dassault Systèmes, the mesostructure of the block copolymer (POS-b-sPPFS) was calculated for different block lengths based on the molecular volume of a repeating unit and the van Krevelen solubility parameter. FIG. 1 visualizes the polymer structure and the corresponding microphase for a given block ratio. The ratio of the block lengths is reflected in the formation of continuous polar, sPPFS phases, which are required for high ionic conductivity. In general, the simulation of the microphases provides indications for the subsequent synthetic production of block copolymers according to the invention.

The above image in FIG. 1 shows the mesostructure of a block copolymer in which the polymer block of the mechanically flexible polymer contains n=200 repeating units and the polymer block of the ion-conducting polymer contains m=50 repeating units. The mesostructure shows that the microphase of the mechanically flexible polymer (dark gray) dominates over the microphase of the ion-conducting polymer (light gray).

The middle figure shows the mesostructure of a block copolymer in which both polymer blocks each contain 50 repeating units. It can be seen that the distribution between the individual microphases is relatively uniform here. The lower figure shows the mesostructure of a block copolymer in which the polymer block made of ion-conducting polymer contains 200 repeating units and the polymer block made of mechanically flexible polymer contains 50 repeating units. It is clear that the microphase of the ion-conducting polymer dominates here.

FIG. 2 shows the structure of the synthesized polymer and HAADF-STEM images at different scales. The light areas correspond to the PWN-60 block, while the dark areas are caused by the microphase or nanophase separation of the octylstyrene block.

FIG. 3 shows a reaction scheme of a further functional modification of the block copolymer. In the first step of a functional modification, partial phosphonation of the polyplentafluorostyrene block takes place. Specifically, the partial phosphonation is carried out using the Michaelis-Arbuzov reaction known from the literature. The block co-polymer POS-b-PPFS (pentafluorostyrene units: 1 eq) was dissolved in DMAc and the phosphonating reagent tris(trimethylsilyl)phosphite (TSP, 0.7 eq) and stirred at 170° C. for 18 hours. After cooling to room temperature, the crude product was precipitated in acetonitrile and filtered off. The filtrate was hydrolyzed in water at 100° C. for 18 h to remove the silyl ester. The polymer was then dissolved in DMAc. Sodium hydrogen sulfide hydrate (5 eq) was dissolved in DMAc with stirring at 50° C. Both mixtures were degassed with argon for a few minutes to remove any remaining oxygen. The PWN60-b-POS solution was then added to the hydrogen sulfide solution at 50° C. under argon countercurrent for 15 minutes and stirred at 50° C. for 20 minutes.

The reaction solution of the partially thiolated block co-polymer was purified by dialysis with water and ethanol to remove excess NaSH. The concentration of the polymer solution was determined gravimetrically. N-methylpyrolidone (NMP) was added to the mixture and excess water and ethanol were removed by reduced pressure to produce a 10 wt % solution of the polymer. A polymer film was drawn from this solution using a squeegee and the membrane was pre-dried at 80° C. for 1.5 h and residual solvent was evaporated at 110° C. for 18 h. The membrane was removed from the glass bath in a water bath. The membrane was removed from the glass substrate in a water bath and placed in a mixture of aqueous H₂O₂ (30 wt %, 12 mL), formic acid (22 mL) and H₂SO₄ (95 wt %, 1.1 mL) for 18 h at room temperature. The membrane and the reaction mixture were then heated to 60° C. for 6 h to ensure oxidation was as complete as possible. The membrane was then removed and washed with demineralized water to a neutral pH value. The membrane of the block co-ionomer contains both phosphonic and sulfonic acid groups in the hydrophilic, proton-conducting nanophase. While proton conductivity is mainly ensured via the sulfonic acid groups when sufficiently moistened with water, conductivity is still ensured via the phosphonic acid groups in the dry state. The sulphonic acid groups, which are more acidic than phosphonic acid groups, can protonate the phosphonic acid groups and thus increase their proton conductivity.

An alternative embodiment of a further functional modification of the block copolymer is shown in FIG. 4.

The block copolymer PPFS-Block-POS is first partially phosphonized.

After partial phosphonation, the block copolymer is dissolved in a dipolar-aprotic solvent such as DMSO, and then the solution is mixed with a dithiol, for example hexane-1,6-dithiol together with the base DBU. The solvent is evaporated, and during evaporation the dithiol cross-links with the remaining para-fluorine positions of the unphosphonated PPFS units. The crosslinking fixes the nanophase-separated structure of the block copolymer. A covalently cross-linked membrane of the phosphonated block copolymer is obtained. The covalently cross-linked membrane is then placed in concentrated sulphuric acid (96% by weight). This sulfonates the octylstyrene blocks. The result is a covalently cross-linked membrane containing both continuous sulfonated and continuous phosphonated nanophases.

The expected nanophase structure is shown in FIG. 5. The simulation shown is based on the already proven nanophase structure. The nanophase structure is stabilized/fixed by crosslinking, which enables subsequent sulfonation of the previously non-polar octylstyrene block while retaining the nanostructure. If concentrated sulfuric acid or oleum is used in the sulfonation of the octylstyrene block, the thiol bridges of the crosslinking sites can be at least partially oxidized to sulfoxide or even sulfone bridges due to the oxidizing properties of concentrated sulfuric acid or oleum, which further chemically stabilizes the crosslinking bridges. Such a phosphonated and sulfonated membrane can presumably be used as a proton conductor for a wider temperature range than sulfonated polymer membranes. At temperatures of <100° C., the sulfonated and phosphonated nanophases conduct protons, while at T>100° C. the phosphonated nanophase conducts protons, since phosphonic acids, unlike sulfonic acids, have an intrinsic conductivity that comes into play when the absence of water at T>100° C. prevents proton conduction in the sulfonated nanophase. In the inner interface between sulfonated and phosphonated nanophases, the sulfonic acid groups, which are more acidic than phosphonic acid groups, can also protonate the phosphonic acid groups, which contributes to a further increase in the proton conductivity of the phosphonic acid groups.

### DESIGN EXAMPLE 1

### Synthesis of polypentafluorostyrene-block-polyisoprene (PPFS-b-PI)

Pentafluorostyrene (here ion-conducting polymer) (50 eq), DDMAT (1 eq) and AIBN (0.2 eq) were dissolved in DMF and the reaction mixture was degassed by three “freeze-vacuum-thaw” cycles to remove any remaining oxygen. The reaction mixture was stirred at 80° C. for 22 hours. The yellow solution was cooled to room temperature and precipitated in methanol. The yellow polymer was filtered off and dried at 60° C. overnight. The dried polymer was dissolved in tert-butyl methyl ether and the precipitation and drying procedure was repeated. The yellow powder (macro-chain transfer reagent, 1 eq) was dispersed in DMF and isoprene (1000 eq), dicumyl peroxide (0.2 eq) were added to the reaction mixture and degassed by two “freeze-vacuum-thaw” cycles. The mixture was transferred to a steel autoclave and filled with DMF (200 mL). The steel autoclave was sealed and the atmosphere was inerted. The reaction mixture was stirred at 115° C. for three days. After cooling to room temperature, the steel autoclave was opened and the precipitated block copolymer was separated from the DMF fraction. The block copolymer was dissolved in THF, concentrated and precipitated in isopropanol. The fine colorless solid was centrifuged off, dried in air at room temperature for three days and a slightly greenish, mechanically flexible block copolymer was obtained.

The molecular weight of the polypentafluorostyrene (PPFS) block and the diblock PPFS-b-PI was determined by gel permeation chromatography (GPC) and end group analysis using 1H-NMR. These are listed in the table below. The results confirm the successful synthesis of PPFS-b-PI.

| | End group | | | |
|---|---|---|---|---|
| | analysis NMR | Mₙ GPC | M_{w} GPC | Dispersity |
| | [kg/mol] | [kg/mol] | [kg/mol] | (M_{w}/Mₙ) GPC |
| PPFS | 11.6 | 9.6 | 10.0 | 1.04 |
| PPFS-b-PI | 23.5 | 20.5 | 24.1 | 1.18 |

The polymerization of the second block was also successfully carried out within a microwave reactor using THE as a solvent instead of DMF. By varying the reaction time, the length of the polyisoprene block (here mechanically flexible polymer) could be successfully controlled.

### Functionalization of PPFS-b-PI by Means of Complete Phosphonation and Partial Thiolation

An example of a further functional modification of the block copolymer obtained in this way is shown schematically in FIG. 7.

Phosphonation of the PPFS block was carried out using the Michaelis-Arbuzov reaction known from the literature. The block copolymer PPFS-b-PI (1 eq) was dissolved in the phosphonation reagent tris(trimethylsilyl)phosphite (TSP, 10 eq) and stirred at 170° C. for 18 hours. After cooling to room temperature, the crude product was precipitated in acetonitrile and filtered off. To remove the silyl ester, the filtrate was hydrolyzed in water at 100° C. for 18 h and then at 50° C. in aqueous HCl (1 M). FIG. 8 compares the ¹⁹F-NMR of the starting product PPFS-b-PI and the phosphonated crude product and confirms the almost complete phosphonation of the PPFS block.

Another example of functional modification, namely partial thiolation, is shown in FIG. 9

The thiolation of the PPFS block is the precursor to sulfonation and the formation of a sulfonimide. The block copolymer PPFS-b-PI (1.2 g, 3.1 mmol pentafluorostyrene units, 1 eq) was dissolved in THF (15 mL). Sodium hydrogen sulfide hydrate (0.9 g; 3.7 mmol, 1.2 eq) was dissolved in THF (15 mL) and water (2 mL) with stirring at 50° C. Both mixtures were degassed by three “freeze-vacuum-thaw” cycles each to remove any remaining oxygen. The PPFS-b-PI solution was then added to the hydrogen sulphide solution at 50° C. under argon countercurrent for 30 minutes. After addition of degassed DMAc (15 mL) under argon, a dark green coloration of the reaction mixture was observed and stirred for 1 h at 50° C. After stirring for another 18 h at room temperature, the crude product was precipitated in acetone. The crude product was filtered off, washed with saturated NaCl solution and cold water. After drying in air for three days, a colorless wax was obtained. FIG. 10 compares the ¹⁹F-NMRS of the starting product PPFS-b-PI and the 88% thiolated crude product.

### DESIGN EXAMPLE 2

### Synthesis of polyoctystyrene-block-polypentafluorostyrene (POS-b-PPFS)

FIG. 11 shows an example of the synthesis of a block copolymer according to the invention (POS-b-PPFS).

DDMAT (1 eq) and AIBN (0.2 eq) were dissolved in 4-n-octylstyrene (75 eq) and the reaction mixture was degassed by three “freeze-vacuum-thaw” cycles to remove any remaining oxygen. The reaction mixture was stirred at 85° C. for 44 hours. The viscous, yellowish crude product was taken up in ethyl acetate and precipitated in isopropanol. The viscous oil was separated and remaining volatile solvents/monomers were removed by heating under high vacuum. The polyoctylstyrene (POS, macro-chain transfer reagent, 1 eq) was dissolved in pentafluorostyrene (75 eq) and added to AIBN (0.2 eq). The reaction mixture was heated at 85° C. for 66 h and a solid polymer block was obtained. This was taken up in THF and the resulting solution was precipitated in isopropanol. The polymer was filtered off and dried overnight at 60° C. in a vacuum drying oven to obtain colorless POS-b-PPFS.

The molecular weight of the POS block and the diblock POS-b-PPFS was determined by gel permeation chromatography (GPC) and end group analysis using 1H-NMR. These are listed in the table below. The results confirm the successful synthesis of POS-b-PPFS.

| | End group | | | |
|---|---|---|---|---|
| | analysis NMR | Mₙ GPC | M_{w} GPC | Dispersity |
| | [kg/mol] | [kg/mol] | [kg/mol] | (M_{w}/Mₙ) GPC |
| POS | 11.6 | 9.9 | 10.4 | 1.04 |
| POS-b-PPFS | 26.0 | 19.9 | 22.6 | 1.14 |

### Functionalization of POS-b-PPFS by Means of Partial Phosphonation

An exemplary functional modification of this block copolymer is shown in FIG. 12.

The partial phosphonation of the PPFS block was carried out using the well-known Michaelis-Arbuzov reaction. The block copolymer POS-b-PPFS (pentafluorostyrene units: 1 eq) was dissolved in DMAc and the phosphonating reagent tris(trimethylsilyl)phosphite (TSP, 0.7 eq) and stirred at 170° C. for 18 hours. After cooling to room temperature, the crude product was precipitated in acetonitrile and filtered off. To remove the silyl ester, the filtrate was hydrolyzed in water at 100° C. for 18 h and then at 50° C. in aqueous HCl (1 M). FIG. 13 compares the ¹⁹F-NMR of the starting product POS-b-PPFS and the phosphonated crude product and confirms the 60% phosphonation of the PPFS block.

In an adapted conductivity measurement, which differs from the above due to the prior immersion of the test membranes in water, a membrane was tested based on the chemical structure in FIG. 2. Compared to a PWN75/PVDF blend membrane, which has a conductivity of 21±1 mS/cm, the nanophase-separated membrane according to the invention showed an approximately 50% higher conductivity of 33±2 mS/cm. Both membranes have a similar proton exchange capacity of about 1.25 and 1.22 mmol/g and are therefore directly comparable. The water absorption of the two polymer membranes is also listed in Table 1. In general, the advantage of nanophase separation is also evident here, as the water uptake of the comparison membrane is about 60% higher than that of the block co-polymer membrane.

| | | Water absorption | |
|---|---|---|---|
| | Conductivity | (wt %) at | Titration of acid |
| Membrane | [mS cm⁻¹] | 25/60/85° C. | protons [mmol g⁻¹] |
| POS-b-PWN-60 | 33 2± | 27/44/71 | 1.22 |
| PVDF-PWN-75 | 21 1± | 44/69/123 | 1.25 |

### DESIGN EXAMPLE 3

### Preparation of a Sulfonated Block Copolymer by Thiolation of a Block Copolymer PPFS-B-POS with Subsequent Oxidation of the Thiol Groups to Sulfonic Acid Groups

The thiolation of the PPFS block is the precursor to sulfonation and the formation of a sulfonimide. The block copolymer PPFS-b-POS (2 g, 4.2 mmol pentafluorostyrene units, 1 eq) was dissolved in THF (10 mL). Sodium hydrosulfide hydrate (1.7 g; 20.9 mmol, 5 eq) was dissolved in DMAc (15 mL) with stirring at 50° C. Both mixtures were degassed with argon for a few minutes to remove any remaining oxygen. The PPFS-b-POS solution was then added to the hydrogen sulfide solution at 50° C. under argon countercurrent for 15 minutes and stirred at 50° C. for 20 minutes. After a further 18 h of stirring at room temperature, a degree of thiolation of 91% was detected in the 19F NMR (partial thiolation). By heating the reaction solution again to 55° C. for 24 h, the degree of thiolation can be increased to 100% (full thiolation).

The reaction solution of the partially thiolated block co-polymer according to the invention was purified by dialysis with water and ethanol to remove excess NaSH. The concentration of the polymer solution was determined gravimetrically. N-methylpyrolidone (NMP) was added to the mixture and excess water and ethanol were removed by reduced pressure to produce a 10 wt % solution of the polymer. A polymer film was drawn from this solution using a squeegee and the membrane was pre-dried at 80° C. for 1.5 h and residual solvent was evaporated at 110° C. for 18 h. The membrane was removed from the glass bath in a water bath. The membrane was removed from the glass substrate in a water bath and placed in a mixture of aqueous H₂O₂ (30 wt %, 12 mL), formic acid (22 mL) and H₂SO₄ (95 wt %, 1.1 mL) for 18 h at room temperature. The membrane and the reaction mixture were then heated to 60° C. for 6 h to ensure oxidation was as complete as possible. The membrane was then removed and washed with demineralized water to a neutral pH value.

The sulphonation by oxidation of the thio group to the sulphonic acid group was confirmed by infrared spectroscopy. The conductivity at room temperature is according to an established literature procedure (Kerres, J.; Ullrich, A.; Haering, T.; Baldauf, M.; Gebhardt, U.; Preidel, W. Preparation, characterization, and fuel cell application of new acid-base blend membranes. Journal of New Materials for Electrochemical Systems 2000, 3 (3), 229-239) 74.1±4.4 mS/cm, while a commercial Nafion membrane (Nafion 211) has a conductivity of 69.7±4.1 mS/cm. The water absorption in water after about 24 hours is 66% at 25° C., 84% at 60° C. and 92% at 85° C. After three days in a water:acetone:isopropanol mixture (v:v:v 1:1:1) at 85° C., a residual mass of 90% by weight of the initial membrane weight was found. Due to the incomplete thiolation/sulfonation and any cross-linking reactions, the proton exchange capacity of 1.25 mmol (H⁺)/g (polymer) is slightly lower than the expected value of the chemical structure in FIG. 5 (1.56 mmol (H⁺)/g (polymer)), but still higher than that of a commercial Nafion membrane (about 0.91 mmol (H⁺)/g (Nafion)).

1. A block copolymer comprising at least two different polymer blocks, wherein one polymer block consists at least predominantly of a first, ion-conducting polymer, wherein the ion-conducting polymer has ion-conducting functional groups, and one polymer block consists at least predominantly of a second, mechanically flexible polymer, wherein the mechanically flexible polymer has a lower glass transition temperature than the ion-conducting polymer.

2. (canceled)

3. (canceled)

4. (canceled)

5. (canceled)

6. The block copolymer according to claim 1, wherein the mechanically flexible polymer does not contain any hydrolysable functional groups.

7. The block copolymer according to claim 1, wherein the mechanically flexible polymer has apolar or non-polar repeating units.

8. The block copolymer according to claim 1, wherein the mechanically flexible polymer is a vinyl-based polymer, in particular polybutadiene, polyisoprene, polypropylene, polyvinylidene fluoride or polyvinyl fluoride, or a substituted styrenated polymer, in particular poly-4-n-octylstyrene.

9. The block copolymer according to claim 1, wherein the ion-conducting polymer comprises or consists of polypentafluorostyrene or analogues thereof.

10. The block copolymer according to claim 1, wherein ion-conducting functional groups of the ion-conducting polymer comprise acidic functional groups, wherein the acidic functional groups comprise in particular sulfonic acid, sulfinic acid, phosphonic acid or sulfonimide or non-ionic forms thereof.

11. The block copolymer according to claim 1, wherein the ion-conducting functional groups of the ion-conducting polymer comprise basic functional groups, the basic functional groups being in particular primary, secondary or tertiary amines, imidazoles, pyrazoles, benzimidazoles, pyridines, or quaternary functional groups, in particular ammonium and/or imidazolium and/or pyrazolium and/or pyridinium groups, pyrazoles, benzimidazoles, pyridines, or quaternary functional groups, in particular ammonium and/or imidazolium and/or pyrazolium and/or pyridinium groups, or cations, in particular tetraalkylphosphonium and/or tetraarylphosphonium and/or metallocene-based anion conductors.

12. The block copolymer according to claim 1, wherein the block of the ion-conducting polymer has an ion-conducting functional group in each repeating unit or has an ion-conducting functional group only in some of the repeating units.

13. The block copolymer according to claim 1, wherein it comprises at least two microphases, one microphase consisting at least predominantly of the ion-conducting polymer and another microphase consisting at least predominantly of the mechanically flexible polymer.

14. The block copolymer according to claim 13, wherein the microphase of the ion-conducting polymer is formed continuously.

15. The block copolymer according to claim 13, wherein the microphase of the ion-conducting polymer has a volume fraction of at least 50%, in particular of at least 60%, preferably of at least 70%.

16. The block copolymer according to claim 13, wherein the microphase of the ion-conducting polymer and/or the microphase of the mechanically flexible polymer is/are designed in such a way that the distance between two opposing interfaces to another microphase is less than 200 nm, in particular less than 150 nm, preferably less than 100 nm, more preferably less than 75 nm, less than 50 nm, less than 35 nm, less than 25 nm or less than 20 nm.

17. The block copolymer according to claim 1, wherein the ratio of the number of repeating units of the block of the ion-conducting polymer to the number of repeating units of the block of the mechanically flexible polymer is at least 10:90, in particular at least 25:75, preferably at least 50:50, and/or at most 90:10, in particular at most 75:25.

18. The block copolymer according to claim 1, wherein polymer blocks of the ion-conducting polymer and/or polymer blocks of the mechanically flexible polymer are each covalently and/or ionically crosslinked with one another or with each other.

19. The block copolymer according to claim 18, wherein partially or perfluoroaromatic compounds are contained or are coupled to the ion-conducting polymer, and in that the blocks of the ion-conducting polymer are covalently crosslinked to one another via their partially or perfluoroaromatic compounds, wherein the partially or perfluoroaromatic compounds are contained in particular in the main chain or a side chain of the respective polymer, and/or wherein, in particular, the partially or perfluoroaromatic compounds contain a partially fluorinated or perfluorinated phenyl unit or a partially fluorinated or perfluorinated biphenyl unit.

20. The block copolymer according to claim 19, wherein the covalent cross-links have the structure S-R-S, wherein the sulphur atoms each substitute a fluorine atom of a partially or perfluoroaromatic compound, and R represents a linear or branched saturated or unsaturated carbon chain, in particular in the form (CH₂)_{X} with X=2-20 or a heteroaromatic chain, in particular poly- or oligoethylene glycol, or any aromatic compound, in particular 1,4-dimercaptobenzene, biphenyl-4,4′-dithiol or toluene-3,4-dithiol.

21. The block copolymer according to claim 18, wherein the ion-conducting polymer contains both acidic and basic functional groups and in that ionic cross-links are formed between the acidic and basic functional groups.

22. The block copolymer according to claim 18, wherein covalent cross-links are formed in the mechanically flexible polymer.

23. A membrane comprising or consisting of a block copolymer according to claim 1.

24. (canceled)

25. (canceled)

26. A process for preparing a block copolymer according to claim 1, comprising the following steps:
provision of a first starting monomer;
provision of a second output monomer;
polymerization of the starting monomers, so that a block copolymer with at least two different polymer blocks is formed, wherein one polymer block consists at least essentially of a first polymer, and wherein one polymer block consists at least essentially of a second, mechanically flexible polymer;
functionalizing the first polymer so that it has an ion-conducting functional group.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)
